(19) United States
(12) Patent Application Publication
(10) Pub. No.: US 2013/0262209 A1
(43) Pub. Date: Oct. 3, 2013

(54) PROVIDING INCENTIVES USING PRODUCT LEVEL DATA

(71) Applicants: R. Steven Boyer, Lighthouse Point, FL (US); Peter K. Gehrke, Chattanooga, TN (US)

(72) Inventors: R. Steven Boyer, Lighthouse Point, FL (US); Peter K. Gehrke, Chattanooga, TN (US)

(73) Assignee: GALILEO PROCESSING, INC., SALT LAKE CITY, UT (US)

(21) Appl. No.: 13/437,591

(22) Filed: Apr. 2, 2012

(51) Int. Cl. G06Q 30/02

(52) U.S. Cl. 705/14.17; 705/14.53

(57) ABSTRACT

A computer-implemented method and system for providing incentives to consumers based on product level data. Information relating to an incentive is defined and stored using, for example, a database accessible by a processing unit. The information relating to the incentive may include a product identifier, such as a stock keeping unit (SKU) number corresponding to a particular product or service. During a transaction between a merchant and a consumer, information may be transmitted to a processing unit, which determines if the information contains the product identifier corresponding to that specified to qualify for the incentive. Information related a payment medium used by the consumer in the transaction may be received and compared to information from an issuer of the payment medium to verify the transaction. The incentive may be provided via a credit to the payment account, or as an online virtual reward on a social networking or gaming website.

### TECHNICAL FIELD

Embodiments of the invention relate generally to electronic payments and to providing incentives to consumers using product level data. More particularly, the invention relates to methods and systems determining whether a consumer qualifies for an incentive, and to providing such an incentive, based on such product level data.

### BACKGROUND

Electronic payments are financial transactions involving the transfer of information through electronic communication methods. For example, when a consumer uses a payment medium, such as a credit card, debit card, near field communication (NFC) or prepaid card, in a transaction with a merchant, the transaction is verified by transferring information electronically from the merchant to one or more parties, such as an issuing bank. Internet-based retail websites enable consumers to purchase goods and services through exchanging information over the Internet. As the use of Internet-based retail websites become more prevalent, the lines between conventional brick and mortar commerce and ecommerce become increasingly blurred.

To take advantage of the evolving world of ecommerce, merchants are making efforts to increase sales through advertising websites that offer coupons or discount vouchers to consumers, such as so-called “deal-of-the-day websites.” Specifically, these websites provide registered consumers with opportunities to purchase discount coupons or vouchers for specified goods and/or services at a particular merchant. The voucher system, at best, provides merchants with limited information for developing marketing strategies. In addition, most merchants using these websites lack the tools and expertise to analyze their long term value. Conventional systems do not provide a way for sponsors, who offers the coupons or discount vouchers, to electronically accumulate product level data to determine the particular products consumers are actually purchasing. For example, if the sponsor presents an offer to the consumer for a rebate on a particular item or service, the merchant will generally use a cash register and/or payment terminal to complete the transaction. Such systems may record information related to the transactions processed, such as total sale, merchant identification number, time, date, terminal number and transaction identification number, but product level detail may not be recorded and is certainly not transmitted to the sponsor.

Accordingly, deal-of-the-day websites have left gaps in the incentive market. Merchants and consumers have expressed frustration about the difficulties in completing the deals in an efficient fashion. Furthermore, considerable time, effort and money are invested to provide incentives to unknown consumers, but there is currently no way for merchants to enhance their consumers' incentive experience.

Access to product level information is valuable in assessing the consumer's purchasing pattern and developing a marketing strategy based on products that the consumer is actually seeking out. This information is also useful to the merchant in recruiting affiliates to sponsor or cosponsor incentives provided by the merchant. Furthermore, the ability to target offers to specific item level products may also allow a merchant to drive sales toward more profitable items or move stale or low performing merchandise.

Accordingly, it would be advantageous to integrate transmission of product level information with electronic payment systems to enable merchants and other interested parties to optimize sales and marketing channels.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment is directed to a method of determining whether a purchase made by a consumer qualifies for an offer from at least one sponsor. The offer may be, for example, some type of purchase incentive provided in exchange for purchase of a particular item. The information about the offer includes a data element indicating at least one item to be purchased in order to qualify for the offer. Information related to a merchant transaction between the consumer and a merchant that includes indications of one or more item purchased by the consumer, such as product level data, may also be received. The information may then be compared to determine a correlation between the offer and the product level data obtained from the merchant transaction, the correlation indicating that the consumer qualifies for the offer.

In another embodiment, a method of determining whether a purchase qualifies for an incentive based on product level data is provided. Merchant transaction information obtained during a transaction between a merchant and a consumer may be received. The merchant transaction information may include, for example, product level data corresponding to at least one item purchased by the consumer. The merchant transaction information may also include one or more identifiers of a payment account used by the consumer, such as the payment account number for an electronic payment medium (e.g., a credit card). The merchant transaction information may be correlated with payment account information received from the issuer of the electronic payment medium is used to make the purchase to determine if the purchase qualifies for the incentive.

In yet another embodiment, a method of providing an incentive to a consumer based on product level data is provided. A sponsor may define information related to an offer (“offer information”) and the offer information may be stored on a database. As used herein, the term “sponsor” may refer to an entity, individual, or some combination of entities and/or individuals, that offer or finance the incentive, or that express or exhibit approval, sponsorship or support of the incentive. The offer may include, for example, providing the consumer with an incentive based on the purchase of a particular product. The offer may be defined using, for example, product level data corresponding to a particular product. For example, to make the purchase, the consumer may use a payment medium (e.g., a credit card) tied to the payment account. Transaction information may be obtained from the merchant. The transaction information may include product level data as well as identification details for payment system used by the consumer to make the purchase. The identification details for the payment system may be used to access transaction records for the associated payment account so that the purchase may be verified. The offer information may be compared with the product level data to determine if the consumer is entitled to the incentive offered by the sponsor.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Additional features and advantages will be set forth in the description which follows. The features and advantages of the invention may be realized and obtained by means of the instruments and combinations particularly pointed out in the appended claims. These and other features will become more fully apparent from the following description and appended claims.

### BRIEF DESCRIPTION OF THE DRAWINGS

To further clarify the above and other advantages and features of the present invention, a more particular description of the invention will be rendered by reference to example embodiments thereof which are illustrated in the appended drawings. It is appreciated that these drawings depict only example embodiments of the invention and are therefore not to be considered limiting of its scope. The invention will be described and explained with additional specificity and detail through the use of the accompanying drawings in which:

FIG. 1 is a block diagram illustrating an embodiment of a computing system means for providing an incentive to a consumer based on product level data;

FIG. 2 is a flow diagram illustrating a method of providing an incentive to a consumer based on product level data; and

FIG. 3 illustrates an example of a processing system means for implementing various aspects of the technology disclosed herein.

### DETAILED DESCRIPTION

Embodiments of the invention relate to methods and systems for providing an incentive to a consumer based on the purchase of a particular product or service. Such incentives may be provided to the consumer automatically by way of a computing system. Product level data may be received and used to determine if the consumer is eligible for the incentive, which may be offered by a merchant or a sponsor. Verification of the consumer's eligibility for the incentive may also be performed by comparing information obtained during a transaction between the consumer and the merchant with information related to purchases made using a payment medium, which may be obtained, for example, from an issuer of the payment account. The incentive may be provided to the consumer in any number of ways including, but not limited to, a rebate by way of a credit to the consumer's payment account, as a virtual reward provided to an account on a social networking (“social networking account”) or gaming website or a monetary amount to a third party such as a charitable cause.

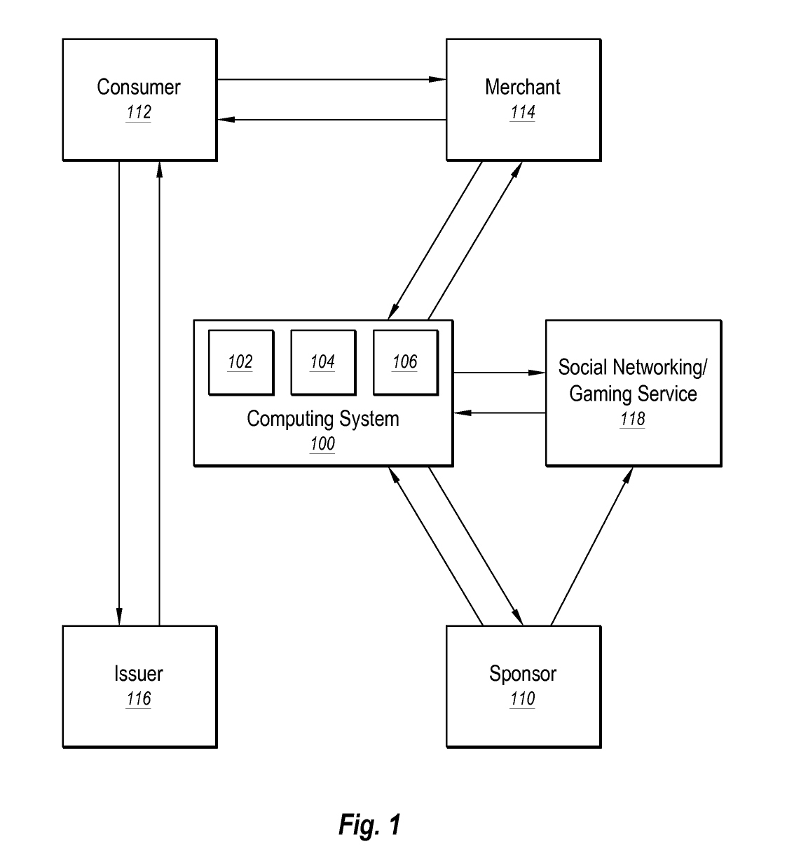

FIG. 1 is a block diagram illustrating an embodiment of a computing system 100 means for providing an incentive to a consumer based on purchase by the consumer of a particular product, which may be resolved using product level data. As used herein, the term “product level data” can refer to data that provides information for specific products available for purchase and may be, for example, a unique identifier or code. The product level data may include any information corresponding to a particular product, such as a stock keeping unit (SKU), a universal product code (UPC), a merchant identifier, a manufacturer identifier, a model number, etc. As used herein, the terms “stock keeping unit” or “SKU” refer to a unique identifier for specific products and services that may be purchased from a merchant. The SKU number generally identifies the name, manufacturer and/or suggested retail price of the item.

The computing system 100 can include a means for processing electronic data, such as a processing unit 102, a means for storing information readable and accessible by the processing unit 102, such as a database 104, and a means for communicating with the Internet or a computer network, such as a communications module 106. The computing system 100 includes software, such as an operating system, and other programs for performing the functions described herein.

The processing unit 102 may be any device capable of executing a set of instructions that specify actions to be taken. For example, the processing unit 102 may include a central processing unit (CPU). The processing unit 102 may be in communication with the database 104, which stores computer-readable information or data. By way of example and not limitation, the processing unit 102 and the database 104 may include random access memory (RAM) or read only memory (ROM). The database 104 may, thus, include a computer-readable carrier medium that stores a computer-readable code (e.g., software) including a set of instructions that are performed when executed by the processing unit 102 during the methods described herein.

The computing system 100 may utilize the communications module 106 to enable communication between the processing unit 102 and the Internet or another computer network. The communications module 106 may include, for example, a modem, an ethernet card, a universal serial bus (USB) interface card, a wireless local area network (WLAN) or any other network device.

A sponsor 110 may decide to offer an incentive, such as a rebate, discount or reward, based on the purchase of a particular item (a good or service). As a non-limiting example, the sponsor 110 may desire to offer a rebate of a predetermined amount to a consumer 112 based on purchase of a particular item. As another non-limiting example, the sponsor 110 may desire to offer an online virtual reward by way of a social networking service or a social gaming service 118.

Such virtual rewards may include, but are not limited to enhancement of a playing character (e.g., a so-called “avatar”), services for performance in a virtual environment, goods or currency for use in the virtual environment, access to a special portal or an advanced level/feature in within a game and/or an increase in playing level within the game. As non-limiting examples, the enhancement of the avatar in the virtual environment may be an enhanced strength, enhanced sexual features, enhanced sight, improve performance skills (e.g., a better shot), etc. As another non-limiting example, the consumer, as a player of the online game, may be rewarded with weaponry and/or real estate (e.g., land, castles, an island, a storefront/shop in a town square, free rent, land grants, etc.). The services for performance in the virtual environment may include, for example, the services of some heralded figure in the virtual environment, castle and lawn care services, personal services for the avatar and/or quest services (e.g., the granting of a mercenary's services for your next quest). The virtual reward may also include a “value exchange” system whereby the consumer may earn “virtual value” from purchases and actions in the real world where the “growing virtual value” increases the incentives and purchasing power in the real world. By way of example and not limitation, the consumer may earn gold coins as virtual rewards and the gold coins may be provided with an exchange rate against a prepaid payment account such that they may be used against purchases in the real world. The virtual reward may also include access to another world, portal access, or some more advanced level or feature of the game only available to those who have received and/or activated the virtual reward in virtual environment. The virtual reward may include providing an avatar with an increased skill level in the game, often referred to as a “level up” or “leveling up.”

A “social networking service” can be a social structure made up of individuals (or organizations), which are tied (connected) by one or more specific types of interdependency, such as friendship, kinship, common interest, financial exchange, dislike, sexual relationships, or relationships of beliefs, knowledge or prestige.

Facebook®, for example, is a social networking service and Web site launched in February 2004. Users must register before using the site, after which they may create a personal profile, add other users such as friends, and exchange messages, including automatic notifications when they update their profile. Additionally, users may join common-interest user groups, organized by workplace, school or college, or other characteristics, and categorize their friends into lists such as “People from Work” or “Close Friends.” Users can create profiles with photos, lists of personal interests, contact information, and other personal information. Users can communicate with friends and other users through private or public messages and a chat feature. They can also create and join interest groups and “like pages” (called “fan pages” until Apr. 19, 2010), some of which are maintained by organizations as a means of advertising.

MySpace® allows users to decorate their profiles using HTML and Cascading Style Sheets (CSS), while Facebook allows only plain text. Facebook has a number of features with which users may interact. They include the Wall, a space on every user's profile page that allows friends to post messages for the user to see; Pokes, which allows users to send a virtual “poke” to each other (a notification then tells a user that they have been poked); photos, where users can upload albums and photos; and Status, which allows users to inform their friends of their whereabouts and actions. Depending on privacy settings, anyone who can see a user's profile can also view that user's Wall. In July 2007, Facebook® social networking website began allowing users to post attachments to the Wall, whereas the Wall was previously limited to textual content only.

Twitter® is an online social networking and microblogging service that enables its users to send and read text-based posts of up to 140 characters, informally known as “Tweets®”. Twitter® social networking website has been compared to a web-based Internet Relay Chat (IRC) client. Tweets® are publicly visible by default; however, senders can restrict message delivery to just their followers. Users can tweet via Twitter® social networking website, compatible external applications (such as for smartphones), or by Short Message Service (SMS) available in certain countries. Users may subscribe to other users' tweets, this is known as “following” and subscribers are known as followers or so-called “tweeps” (Twitter®+peeps). Twitter® social networking website social networking site allows users the ability to update their profile by using their mobile phone either by text messaging or by apps released for certain smartphones/tablets. As a social network, Twitter® revolves around the principle of followers. When you choose to follow another user of Twitter®, that user's Tweets® appear in reverse chronological order on your main page on Twitter®.

A “social gaming service” can be a web-based game that is played with other individuals and may include online sharing of content that facilitates interaction between the individuals. The social gaming service may be built on a social networking service to integrate an online community with the social network. The social gaming services were developed as existing video games were revised to include social network integration and as social games were developed for use with existing social networks. Developers of social gaming services include, but are not limited to, Zynga®, Crowdstar®, Playdon™ and Playfish®. The games are generally strategy or role-playing games that take place through a social networking service, such as Facebook or MySpace and involve multiple players. The players generally play through an online character or identity, such as by using a so-called “avatar.”

Popular examples of social gaming services include Zynga's Cityville®, Farmville®, and Mafia Wars® games, and Electronic Arts, Inc.'s The Sims Social™ game, each of which is accessed and played via Facebook® social networking service. Similar games are also available for other social networks, such as MySpace®. To incentivize players, these types of social networking and social gaming services often provide online rewards, such as limited edition online virtual goods. As a non-limiting example, the sponsor 110 may be a social gaming service that may offer such virtual rewards. As other non-limiting examples, the sponsor 110 may be separate from the social networking or gaming service 118 and may collaborate with the social networking or gaming service 118 to provide an online virtual reward as an incentive for the purchase of a particular product.

In some embodiments, the merchant 114 may collaborate with a manufacturer of a product so that the merchant 114 may offer the consumer 112 some type of incentive (e.g., a rebate, reward or discount) on at least one product obtained from the manufacturer. For example, the merchant 114 may have an overstock of the manufacturer's product and may arrange the incentive for purchase of the product with the manufacturer, who acts as the sponsor 110 for the promotion. As a non-limiting example, the manufacturer (e.g. sponsor 110) may collaborate with the social networking or gaming service 118 to provide the online virtual reward to the consumer 112 as the incentive for purchasing the product. As another non-limiting example, the manufacturer (e.g. sponsor 110) may provide the funds for the incentive.

As an illustrative example, the product for which the incentive is offered may be a brand name television manufactured or wholesaled by the sponsor 110. The sponsor 110 and the social networking or gaming service 118 may cooperate to provide a limited number of virtual televisions bearing the brand name for posting to the account with the social networking or gaming service 118. The consumer 112 may obtain the social networking account through a registration process which may take place over a network, such as the Internet. As the incentive for purchase of the brand name television, the merchant 114 may offer the consumer 112 the virtual brand name television which will be provided to the consumer 112 via the social networking account. By limiting the number of virtual rewards available or a length of time during which the virtual rewards are available, the merchant 114 may create a sense of urgency for the consumer 112 to purchase a particular product. The incentive is, therefore, beneficial to the merchant 114 and the sponsor 110 (e.g., the manufacturer).

In other embodiments, the sponsor 110 may enable the merchant 114 to define the incentive or to register to provide a predetermined incentive defined by the sponsor 110 using, for example, a web-based tool (not shown), which may communicate with the computing system 100 to store information related to the incentive on the database 104.

Regardless of the type of incentive, the sponsor 110 provides at least a portion of the funds for the incentive (e.g., a rebate) or arranges for the incentive (e.g., a virtual reward) to be provided to the consumer 112, as will be described in further detail. For example, the sponsor 110 of the incentive may be a manufacturer or producer of goods, a provider of a service, a credit card service, or the merchant 114. As non-limiting examples, the sponsor 110 may be a manufacturer or wholesaler of a particular item, a multi-brand corporation or conglomerate, an issuer 116 (e.g., an issuing bank or credit union for a payment medium or payment account) and/or the social networking or gaming service 118. In addition, two or more companies, such as a manufacturer of a particular product and the social networking or gaming service 118, may act together as cosponsors for the incentive. While FIG. 1 is illustrated with a single box representing the computing system 100, the sponsor 110, the consumer 112, the merchant 114, the issuer 116 and the social networking or gaming service 118, it is to be understood that more than one of any of these components may be included. Accordingly, any number of sponsors 110, consumers 112, merchants 114, issuers 116 and social networking or gaming services 118 may be in communication with one another and/or with any number of computing systems 100 for processing electronic data.

The issuer 116 may be a financial institution that issues the payment medium to the consumer 112 and provides payment to the merchant 114 (e.g., via a merchant bank, not shown) for the transaction. The issuer 116 then settles the payment with the consumer 112 by billing the consumer 112 for the payment or debiting the consumer's payment account for the amount of the payment. The issuer 116 may guarantee payment for authorized transactions made by the consumer 112 using the payment medium.

The consumer 112 may make a purchase from the merchant 114 offering an item qualifying for the incentive from the sponsor 110. To make the purchase, the consumer 112 may present the payment medium for which the consumer 112 holds an account with the issuer 116. The payment medium may be, for example, a credit card, a debit card, a gift card, a reward card, a mobile wallet, a near field communication (NFC) code or an EMV card. Information related to the payment medium, such as account number or code (“payment identifier”), may be transmitted to the computing system 100 where it is received by the processing unit 102.

In one embodiment, the product level data may be transmitted to the computing system 100 by the consumer 112. In such an embodiment, the consumer 112 may complete a transaction with the merchant 114 using a credit card as the payment medium. After the transaction is executed, product level data corresponding to at least one item purchased by the consumer 112 may be transmitted to the computing system 100 by the merchant 114 or the consumer 112. For example, the merchant 114 may provide the consumer 112 with an acknowledgement of the sale that includes the product level data, such as a receipt or a proof of purchase. The product level data may include data that may be used by the processing unit 102 to correlate the particular item purchased by the consumer 112 with information stored on the database 104, as will be described in further detail.

For example, the database 104 may include stored information related to the merchant 112 (“merchant information”) and information related to the incentive (“incentive information”). The incentive information may include information for identifying the sponsor 110 providing the offer, the product level data for identifying the specific products to which the incentive applies as well as the details of the incentive (e.g., the amount of the incentive, conditions for receiving the incentive, etc.). As a non-limiting example, the sponsor 110 may offer a rebate on a particular type of product and the incentive information may specify the name of the sponsor 110, product level data corresponding to the product, and an amount of the rebate. As another non-limiting example, the sponsor 110 may offer an online reward for the purchase of a particular product, and the incentive information may specify the name of the sponsor 110, product level data corresponding to the product, the online reward and the social networking or gaming service 118. In such an example, the online reward such as 10 Farmville coins may be posted to the account held by the consumer 112 with the social networking or gaming service 118.

The incentive information may be specified by the sponsor 110 and stored on the database 104. For example, the sponsor 110 may define the incentive information and transmit that information to the computing system 100 (e.g., via the web-based tool) where the information is stored on the database 104.

The database 104 may also store information related to the transaction between the merchant 114 and the consumer 112 (“transaction information”). For example, the transaction information may include details, such as merchant's name, merchant's address, merchant's phone number, date and time of transaction, amount of transaction, approval code and account holder name. For example, the transaction information may be generated as a listing of transactions from a so-called “close” process during which daily batches of transactions are summarized and transmitted for end of day settlement processing.

The transaction information may be stored on the database 104 or, alternatively, may be obtained from the issuer 116 of the payment medium used by the consumer 112 in the transaction with the merchant 114. For example, the processing unit 102 may be configured to communicate with the issuer 116 to receive information, such as transaction information, from the issuer 116.

In some embodiments, the consumer 112 may obtain a copy of the product level data obtained during the transaction and may transmit the product level data to the computing system 100. As non-limiting examples, the consumer 112 may scan or photograph a receipt provided by the merchant 114 and may transmit the scanned document or the photograph showing the product level detail to the computing system 100. The computing system 100 may receive the product level data transmitted by the consumer 112. For example, the consumer 112 may use a mobile device (e.g., a mobile phone or a tablet device) to transmit the product level data, which is received by the computing system 100.

In another embodiment, the product level data may be transmitted to the computing system 100 by the merchant 114. For example, the product level data may be obtained using a point of sale (POS) system (not shown) used by the merchant 114 to conduct the transaction. The POS system may include, for example, a POS terminal for displaying information related to the transaction and a POS reader device for reading and transferring information related to the financial payment medium (“payment information”). The POS system may be equipped with hardware and software for facilitating the transaction between the consumer 112 and the merchant 114. The POS system may be configured to communicate directly or indirectly with the processing unit 102 of the computing system 100 such that the computing system 100 received the payment information transferred from the POS system.

Before a transaction made with a payment medium can be completed, payment authorization may be requested from and provided by the issuer 116 of the payment medium. A request for payment authorization is presented to the issuer 116 to ensure the consumer has adequate funds available for the transaction against their line of credit. For example, the issuer 116 may be provided with the account identifier and details of the transaction to determine if adequate funds are available and, assuming funds are available, may generate an authorization code, which is transmitted to the merchant 114. The merchant 114 may transmit the payment request authorization electronically through a credit card processing terminal or by telephone as a voice authorization using the payment identifier. The payment request may optionally be facilitated by a third party payment processor, such as an acquirer, that transmits the payment request to the issuer 116.

In some embodiments, the computing system 100 may additionally function as a third party payment processor for the payment medium (e.g., a credit card processor) or may be a clearing house, which provides electronic funds transfer for interbank clearing of electronic payments for the issuer 116. In some embodiments, upon receiving transaction information from the consumer 112, the merchant 114 or an intermediary, such as a third party payment processor, the computing system 100 authenticates the transaction information by performing a comparison with information obtained from the issuer 116. The computing system 100 communicates with the issuer 116 to receive transaction information (information related to transactions made by the consumer 112 using the payment medium). The transaction information may be that acquired by the issuer 116 during payment authorization, such as, a total purchase amount, the merchant identifier, the transaction identification number, etc. The computing system 100 may receive the transaction information from the issuer 116 using the processing unit 102 and may compare that information to the transaction information, which may be stored on the database 104, to authenticate the transaction. Receiving the information related to the transaction from the point of purchase (e.g., the merchant 114 or the consumer 112) and the point of authorization (e.g., the issuer 116) enables the computing system 100 to verify that a transaction took place before determining if the consumer 112 qualifies for the incentive.

As a non-limiting example, the computing system 100 may receive a receipt from the consumer 112 or may receive a batch of receipts from the merchant 114 using the processing unit 102. Using the processing unit 102, the computing system 100 may compare the transaction information shown on the receipt(s) with transaction information obtained from the issuer 116, which may be stored on the database 104. As a particular example, the computing system 100 may receive a copy of receipt from the consumer 112 that shows a purchase for a certain dollar amount and the computing system 100 may match this dollar amount against the transaction information provided by the issuer 116 to verify that the transaction occurred. Matching the transaction information from the merchant 114 with that of the issuer 116 prevents fabrication of transactions qualifying for the incentive.

The computing system 100 may also compare the product level data with incentive information to determine if the consumer 112 qualifies for an incentive. Optionally, the computing system 100 may send a notification to the sponsor 110 indicating that the consumer 112 qualifies for the incentive and/or that the incentive may be provided to the consumer 112. For example, the computing system 100 may generate an electronic notification using the processing unit 102 and may transmit the electronic notification to the sponsor 110 using the communications module 106.

After determining that the consumer 112 is entitled to the incentive, the incentive may be provided to the consumer 112 by using the computing system 100. In some embodiments, the incentive may be an online virtual reward. In such an embodiment, the computing system 100 may be used to generate a notification requesting that the social networking or gaming service 118 provide the online virtual reward to the consumer 112 via the social networking account held by the consumer 112, or the computing system 100 may be in communication with the social networking or gaming service 118 and the online virtual reward may be provided directly to the consumer's 112 social networking account. As another non-limiting example, the incentive may be a rebate and the computing system 100 or the sponsor 110 (which may be the issuer 116) may provide funds for the rebate directly to the consumer 112 by way of a credit to the payment account used by the consumer 112 to make the transaction qualifying for the incentive. The computing system 100 therefore enables incentives to be provided to the consumer based on product level data.

The consumer 112 may be an account holder with the social networking or gaming service 118. The social networking service or a social gaming service 118 may determine using, for example, registration information provided by the consumer 112, that the consumer 112 may be interested in participating in a program for incentives and discounts at participating merchants or other locations. The consumer 112 may elect to participate in (i.e., “opts in”) to the program. For example, the consumer 112 may opt-in to the program using the computing system 100. The computing system 100 may then credit card, Debit Card, Prepaid Card, or other transactional statements. The consumer 112 will then receive offers from the sponsor 110 that they may take advantage of, and if they do, the computing system 100 will receive a detailed file of transactions taking place at a specific time and location will be able to match the detailed file of transactions to the consumer's settlement statement from the issuing bank.

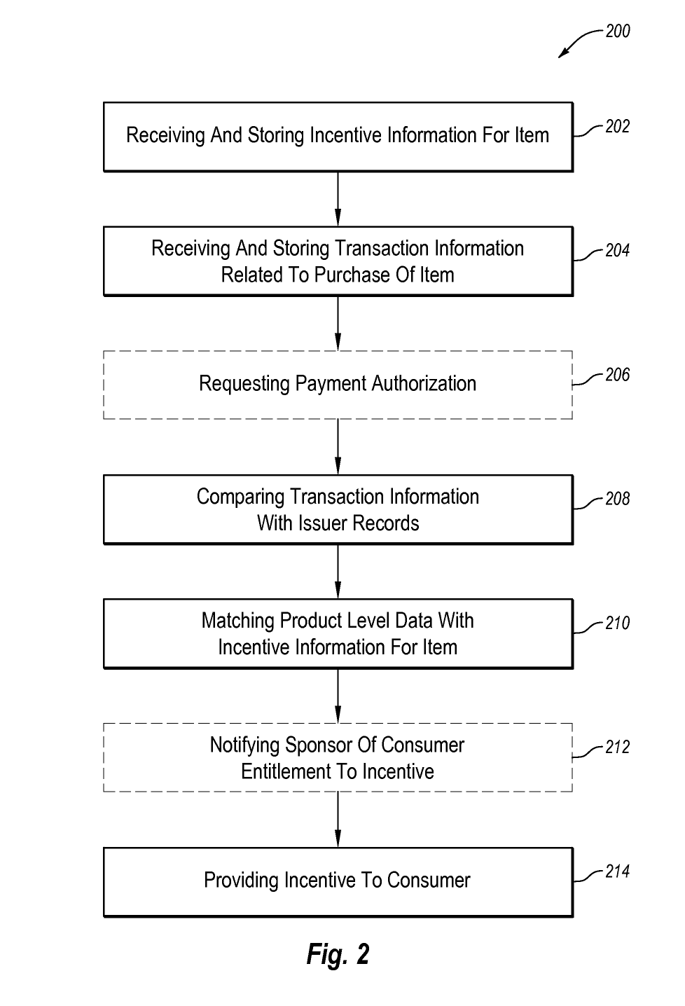

FIG. 2 is a flow diagram illustrating an embodiment of a method 200 of providing an incentive to a consumer based on a particular purchase. A sponsor may define an incentive, such as a rebate, discount or reward, based on the purchase of a particular item (a good or service). As a non-limiting example, the incentive may be a rebate of a predetermined amount or an online virtual reward that will be provided to the consumer in a social networking or gaming service for which the consumer holds an account. The consumer may use a payment medium, such as a credit card or debit card, to make the purchase from the merchant. The incentive information is transmitted to a trusted authority, where it may be received and stored 202 as computer-readable data using a system, such as the computing system 100 shown in FIG. 1. For example, the incentive information may be received by the trusted authority using, for example, the processing unit 102 of the computing system 100 and may be stored as a first set of data on computer-readable medium, such as that of the database 104 of the computing system 100.

A transaction may take place between the consumer and a merchant wherein the consumer purchases the particular item for which the incentive is offered from the merchant. The merchant or the consumer may transmit information pertaining to the transaction, including product level data (e.g., a SKU number or UPC code), to the trusted authority. The trusted authority may receive and store 204 the transaction information as a second set of data using, for example, the processing unit 102 and the database 104 of the computing system 100 shown in FIG. 1.

Optionally, the trusted authority may request payment verification 206 (shown in broken lines) for the transaction from the issuer of the payment medium used by the consumer in the transaction. For example, the verification request may be generated and transmitted to the issuer of the payment medium using the processing unit 102 and the communications module 106 of the computing system 100 shown in FIG. 1.

The transaction information may then be compared 208 with transaction records held by the issuer to verify the transaction using, for example, the processing unit 102 of the computing system 100 shown in FIG. 1. Accessing and comparing this information provides the trusted authority with ability to verify whether the transaction took place, thus preventing fraudulent or mistaken reporting of transactions.

The product level data corresponding to one or more items purchased in the transaction (e.g., the second set of data) may then be matched 210 against the incentive information (e.g., the first set of data) to determine if the consumer qualifies for the incentive from the sponsor. For example, using the processing unit 102 of the computing system 100 shown in FIG. 1, the product level data (e.g., a SKU number) may be compared with incentive information (e.g., SKU numbers) stored on the database 104.

If the product level data corresponds to that specified by the sponsor in association with the incentive (e.g., the first set of data and the second set of data include common product identifiers) the trusted authority may, optionally, notify 212 the sponsor that the consumer is entitled to the incentive (shown in broken lines). The trust authority may notify the sponsor using any means of communication. As a non-limiting example, the trust authority may generate an electronic notification using the processing unit 102 of the computing system 100 shown in FIG. 1 and may transmit the electronic notification to the sponsor using the communications module 106 of the computing system 100 shown in FIG. 1.

The incentive may then be provided 214 to the consumer by the trusted authority, the sponsor or the social networking or gaming service for which the consumer holds an account. In some embodiments, the trusted authority may provide the incentive to the consumer by applying a credit directly to the payment account used by the consumer in the transaction. In other embodiments, the trusted authority may notify the social networking or gaming service that the consumer is entitled to the incentive, or may linked to the social networking or gaming service such that the trusted authority may directly provide the incentive to the consumer via the social networking or gaming service. For example, the trusted authority may be linked to the social networking or gaming service via the communications module 106 of the computing system 100 shown in FIG. 1, and the processing unit 102 may be used to provide the incentive to the consumer's account with the social networking or gaming service.

The embodiments described herein may include the use of a special purpose or general-purpose computer including various computer hardware or software modules, as discussed in greater detail below.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a physical network or another physical communications connection to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated.

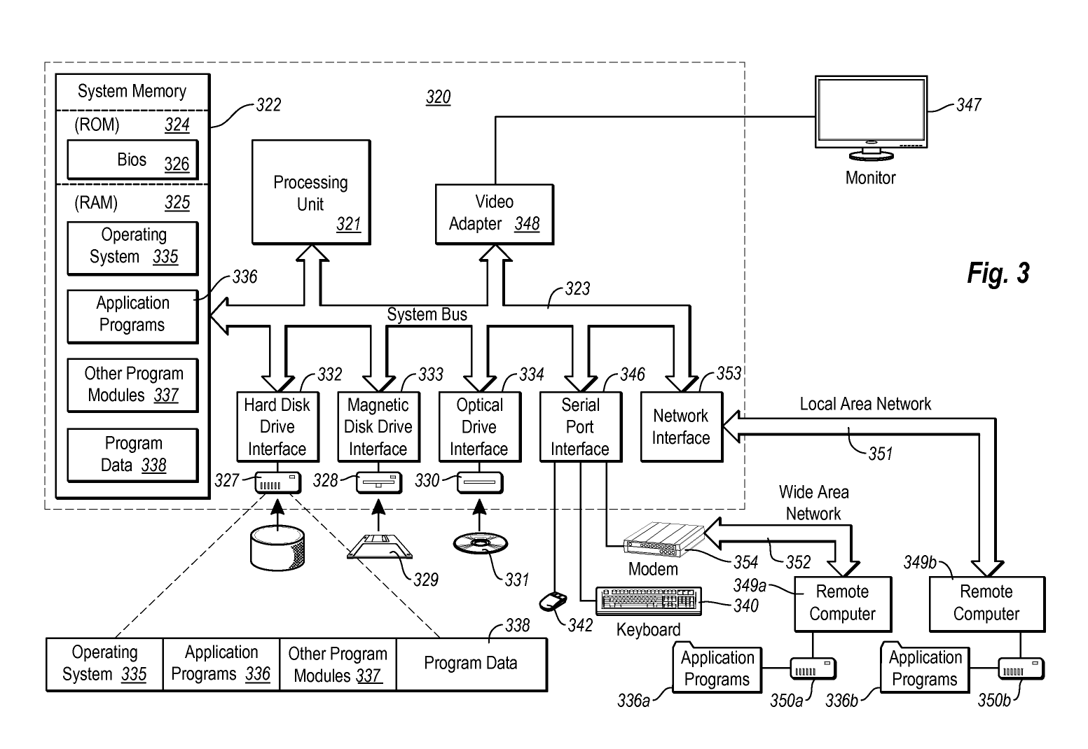

With reference to FIG. 3, an example of a processing system for implementing at least portions of the technology herein includes a general purpose computing device in the form of a computer 320. Components of computer 320 may include, but are not limited to, a processing unit 321, a system memory 322, and a system bus 323 that couples various system components including the system memory to the processing unit 321. The system bus 323 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Processing means, such as computer means 320 or the processor of mobile phone, tablet PC, or other processing device typically includes a variety of computer readable media. Computer readable media can be any available media that can be accessed by computer 320 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible means or medium which can be used to store the desired information and which can accessed by computer 310.

Referring still to FIG. 3, the system memory 322 includes computer storage media in the form of volatile and/or nonvolatile memory such as read only memory (ROM) 324 and random access memory (RAM) 325. A basic input/output system 326 (BIOS), containing the basic routines that help to transfer information between elements within computer 320, such as during start-up, is typically stored in ROM 324. RAM 325 typically contains data and/or program modules that are immediately accessible to and/or presently being operated on by processing unit 321. By way of example, and not limitation, FIG. 34 illustrates operating system 335, application programs 336, other program modules 337, and program data 338.

The computer 320 may also include other removable/non-removable, volatile/nonvolatile computer storage media. By way of example only, FIG. 3 illustrates a hard disk drive 327 that reads from or writes to non-removable, nonvolatile magnetic media, a magnetic disk drive 328 that reads from or writes to a removable, nonvolatile magnetic disk 329, and an optical disk drive 330 that reads from or writes to a removable, nonvolatile optical disk 331 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 327 is typically connected to the system bus 323 through a non-removable memory interface such as interface 332, the magnetic disk drive 333 is typically connected to the system bus 323 by a removable interface, such as interface 333, and the optical disk drive is typically connected to the system bus 323 by a removable interface, such as interface 334.

The drives and their associated computer storage media discussed above and illustrated in FIG. 3 data for the computer 320. In FIG. 3, for example, hard disk drive 332 is illustrated as storing operating system 335, application programs 336, other program modules 337, and program data 338. Note that these components can either be the same as or different from operating system 335, application programs 336, other program modules 337, and program data 338. Operating system 335, application programs 336, other program modules 337, and program data 338 are given different numbers here to illustrate that, at a minimum, they are different copies. A user may enter commands and information into the computer 320 through input devices such as a keyboard 340 and pointing device 342, commonly referred to as a mouse, trackball or touch pad. Other input devices (not shown) may include a microphone, joystick, game pad, satellite dish, scanner, or the like. These and other input devices are often connected to the processing unit 321 through a user input interface 346 that is coupled to the system bus, but may be connected by other interface and bus structures, such as a parallel port, game port or a universal serial bus (USB). A monitor 347 or other type of display device is also connected to the system bus 323 via an interface, such as a video interface 348. In addition to the monitor 348, computers may also include other peripheral output devices such as speakers and printer, which may be connected through an output peripheral interface.

The computer 320 may operate in a networked environment using logical connections to one or more remote computers, such as remote computers 349a and 349b. The remote computers 349a and 349b may be a personal computer, a server, a router, a network PC, a peer device or other common network node, and typically includes many or all of the elements described above relative to the computer 320, although only memory storage devices 350a and 350b have been illustrated in FIG. 3. The logical connections depicted in FIG. 3 include a local area network (LAN) 351 and a wide area network (WAN) 352, but may also include other networks. Such networking environments are commonplace in offices, enterprise-wide computer networks, intranets and the Internet.

When used in a LAN networking environment, the computer 320 is connected to the LAN 352 through a network interface or adapter 353. When used in a WAN networking environment, the computer 320 typically includes a modem 354 or other means for establishing communications over the WAN 352, such as the Internet. The modem 354, which may be internal or external, may be connected to the system bus 323 via the user input interface 346, or other appropriate mechanism. In a networked environment, program modules depicted relative to the computer 320, or portions thereof, may be stored in the remote memory storage device. By way of example, and not limitation, FIG. 3 illustrates remote application programs 336a and 336b as residing on memory device 350a and 350b. It will be appreciated that the network connections shown are exemplary and other means of establishing a communications link between the computers may be used.

Explanation of the Internet, computers, and networks can also be understood by reading “How the Internet Works” seventh ed. by Preston Gralla (2004) Que Publishing, “How Networks Work”, seventh ed. by Frank Derfler Jr. and Les Freed (2005) Que Publishing, and “How Computers Work” seventh ed. by Ron White (2004) Que Publishing, the contents of all three books are hereby incorporated by reference herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. At a processing unit within a computing system including the processing unit and a database, a method of determining whether a purchase made by a consumer qualifies for an incentive offered by at least one sponsor, the method comprising:
receiving incentive information related to the incentive offered by the at least one sponsor, the information including first data corresponding to at least one item that may be purchased to qualify for the incentive;
receiving transaction information from a merchant related to a transaction between the consumer and the merchant, the transaction information including second data corresponding to at least one item purchased by the consumer; and
comparing the incentive information and the transaction information to determine a correlation between the first data and the second data indicating that the consumer qualifies for the incentive offered by the at least one sponsor.

2. The method of claim 1, wherein receiving the incentive information related to the incentive offered by the at least one sponsor comprises receiving product level data corresponding to the at least one item that may be purchased to qualify for the incentive.

3. The method of claim 2, wherein receiving the transaction information from the merchant comprises receiving information related to a financial instrument to the consumer by an issuer, wherein a payment medium is used by the consumer in the transaction.

4. The method of claim 3, further comprising verifying that the transaction occurred by determining whether the transaction information from the merchant correlates with information obtained from the issuer including a summary of transactions made by the consumer using the payment medium.

5. The method of claim 3, further comprising requesting payment verification from the issuer for the payment medium used by the consumer in the transaction using the processing unit.

6. The method of claim 1, wherein comparing the incentive information and the transaction information to determine a correlation between the first data and the second data comprises comparing the incentive information and the transaction information to determine a product identifier contained in the first and second data, the product identifier corresponding to at least one item.

7. The method of claim 1, further comprising forming an electronic notification including information for delivery to at least one sponsor including instructions to provide the incentive to the consumer.

8. At a processing unit within a computing system, a method of determining whether a consumer qualifies for an incentive based on product level data, the method comprising:
receiving purchase information related to the purchase of at least one item by the consumer, the information including product level data corresponding to the at least one item and an identifier corresponding to a payment account used by the consumer; and
correlating the product level data with information specifying items for which the incentive is offered to determine whether the consumer qualifies for the incentive, the information provided by a sponsor and stored in a location accessible by the processing unit.

9. The method of claim 8, further comprising receiving transaction information related to the purchase made by the consumer using the payment medium, the information including an account identifier corresponding to a the payment medium.

10. The method of claim 9, further comprising correlating the account identifier with information obtained from an issuer of the credit card related to a purchase made using the account to authenticate the purchase of at least one item by the consumer.

11. The method of claim 8, wherein correlating the product level data with the information specifying items for which the incentive is offered comprises matching a product identifier against the information specifying items for which the incentive is offered.

12. The method of claim 8, further comprising requesting payment verification for the payment medium used by the consumer, the request made using the processing unit to communicate with an issuer of the payment medium.

13. The method of claim 8, further comprising providing the incentive to the consumer.

14. The method of claim 13, wherein providing the incentive to the consumer comprises issuing a credit directly the payment account.

15. The method of claim 13, wherein providing the incentive to the consumer comprises providing a reward to an account held by a consumer with a social gaming service.

16. The method of claim 8, further comprising generating an electronic notification indicating the consumer qualifies for the incentive for delivery to at least one of the sponsor or a social networking or social gaming service.

17. In a computing system including a processing unit and a database accessible by the processing unit, a method of providing an incentive to a consumer based on product level data, the method comprising:
storing incentive information defined by a sponsor using the database, the incentive information including a product identifier corresponding to a particular product for which the sponsor is offering the incentive;
receiving transaction information from a merchant, the transaction information relating to a transaction between a merchant and the consumer in which a payment medium for which the consumer holds an account with an issuer is used;
obtaining payment information from the issuer of the payment medium using the processing unit, the payment information including information related to transactions executed with the payment system;
comparing, using the processing unit, the payment information with the transaction information to verify the transaction using the payment medium occurred between the merchant and the consumer; and
comparing, using the processing unit, the incentive information with the transaction information to determine if the transaction information includes the product identifier indicating that the consumer is entitled to the incentive offered by the sponsor.

18. The method of claim 17, wherein comparing, using the processing unit, the incentive information with the transaction information comprises matching product level data in the incentive information with that in the transaction information.

19. The method of claim 18, further comprising providing the incentive to the consumer via a social networking service or a social gaming service.

20. The method of claim 19, wherein providing the incentive to the consumer via a social networking service or a social gaming service comprises directing a virtual reward to be provided to the consumer via an account held by the consumer with the social networking service or the social gaming service.
